(19) United States
(12) Patent Application Publication
(10) Pub. No.: US 2022/0219450 A1
(43) Pub. Date: Jul. 14, 2022

(54) ACCURATE DETECTION OF A PRINT START LOCATION

(71) Applicant: Hewlett-Packard Development Company, L.P., Spring, TX (US)

(72) Inventors: Jody Lee Clayburn, Vancouver, WA (US); Stephen Thomas Rohman, Vancouver, WA (US); Lorraine T. Golob, Vancouver, WA (US)

(73) Assignee: Hewlett-Packard Development Company, L.P., Spring, TX (US)

(21) Appl. No.: 17/613,978

(22) PCT Filed: Sep. 9, 2019
(86) PCT No.: PCT/US2019/050190

§ 371 Date: Nov. 24, 2021

(51) Int. Cl. B41J 2/045

(52) U.S. Cl. CPC B41J 2/04508

(57) ABSTRACT

Examples of printing devices and print guides for accurate detection of a print start location are described herein. In some examples, a printing device may include a marker sensor to detect a print start marker on a print guide as the printing device moves on the print guide. The print start marker may be located on the print guide at a distance before a print start location. The print guide may have a reference marker located in relation to the print start location to provide an accurate indication of the print start location to a user. The print guide may be physically separate from a print media. In some examples, the printing device may also include a distance measurement sensor to measure distance traveled by the printing device after detecting the print start marker. The distance measurement sensor may trigger a start of printing at the print start location.

### BACKGROUND

Printing devices may apply a print substance to a print media. In some examples, a printing device may apply ink to a paper media. In other examples, the printing device may apply a fluid other than ink to the print media.

### BRIEF DESCRIPTION OF THE DRAWINGS

Various examples will be described below by referring to the following figures.

FIG. 1 is a plan view of an example of a printing device and a print guide;

FIG. 2 is a cross section elevation view of an example of a printing device and a print guide;

FIG. 3 is a plan view of an example of a print guide;

FIG. 4 illustrates examples of signals generated by the printing device;

FIG. 5 is an example of multi-line sequence printing on a print media; and

FIG. 6 is a flow diagram illustrating an example of a method for accurate detection of a print start location.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

### DETAILED DESCRIPTION

A printing device may apply a print substance to a print media. Examples of printing devices include printers, copiers, fax machines, multifunction devices including additional scanning, copying, and finishing functions, all-in-one devices, pad printers to print images on three dimensional objects, and three-dimensional printers (additive manufacturing devices).

In some examples, the print substance may include printing agents or colorants. The printing device may apply the print substance to a substrate. A substrate is a superset of print media, such as plain paper, and can include any suitable object or materials to which a print substance from a printing device is applied including materials, such as powdered build materials, for forming three-dimensional articles. In addition, in some examples, a printing device may print on various media such as inanimate objects, skin, books, wood, plastic, metal, concrete, wallpaper, or other materials. Print substances, including printing agents and colorants, are a superset of inks and can include toner, liquid inks, or other suitable marking material that may or may not be mixed with fusing agents, detailing agents, or other materials and can be applied to the substrate.

In other examples, the printing device may be a fluid ejection device. For example, the printing device may be used in life-science applications (e.g., lab-on-chip fluidic designs), bio-printing, printed manufacturing features and sensors for additive manufacturing applications. These applications may use a print substance other than ink or toner.

Examples of methods to improve image placement by a printing device are described herein. In some examples, the printing device may be a handheld printer. The printing device may include a sensor to detect device movement. In some examples, the printing device may use the sensor to detect a print start marker indicative of the position of the device within a print guide. The sensor may trigger a signal as the printing device advances within the print guide. A distance measurement sensor of the printing device may provide an accurate measure of distance traveled.

In some examples, the print guide may include a reference marker to provide a very accurate representation of a print start location to a user. The location of the reference marker may be configured as a known distance from the print start marker sensed by the sensor. The sensor and reference marker may enable edge alignment of print media. The edge alignment may further enable accurate multi-line sequence printing (e.g., stitching) when the user manually sequences multiple print swaths on the print media.

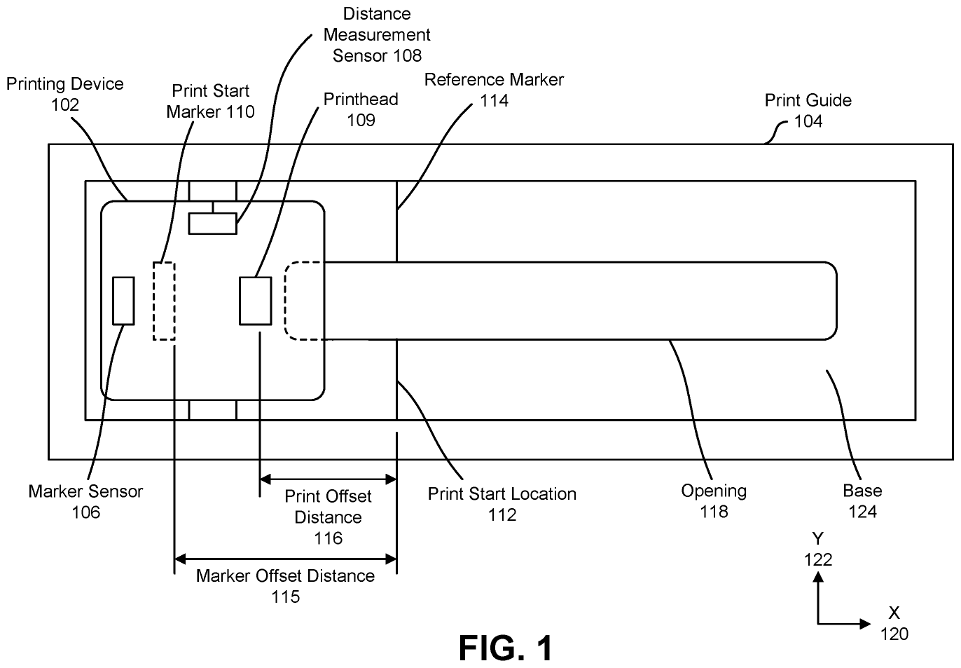

FIG. 1 is a plan view of an example of a printing device 102 and a print guide 104. The printing device 102 may apply a print substance to a print media.

In some examples, the printing device 102 may be a handheld printing device. For example, a user may manually move the printing device 102 over a print media. The printing device 102 may measure its movement and may apply a print substance as the user moves the printing device 102.

The print guide 104 may be used to facilitate accurate printing. The print guide 104 may be used to align the printing device 102 to the print media. In some examples, the print guide 104 may constrain movement of the printing device 102 in one direction while allowing movement of the printing device 102 in another direction. In this example, the print guide 104 allows movement of the printing device 102 along an X-axis 120 over a certain distance. The print guide 104 limits movement of the printing device 102 along a Y-axis 122.

In some examples, the printing device 102 may be easily removable from the print guide 104. For instance, a user may place the printing device 102 within the print guide 104 to print. The user may then lift the printing device 102 out of the print guide 104 after printing. In some examples, the printing device 102 may not be physically attached to the print guide 104.

In some examples, the print guide 104 may include a base 124 upon which the printing device 102 moves. The base 124 of the print guide 104 may have an opening 118 through which the printing device 102 prints on the print media. Therefore, the print guide 104 may be positioned between the printing device 102 and the print media. In some examples, the base 124 may be fabricated from a transparent material to facilitate placement of the print guide 104 on the print media.

The printing device 102 may include a marker sensor 106 to detect a print start marker 110 on the print guide 104 as the printing device 102 moves on the print guide 104. The print start marker 110 may be located on the print guide 104 at a distance before a print start location 112. As used herein, the print start location 112 is the beginning of a region in which printing may take place. For example, the printing device 102 may print on the print media starting at the print start location 112. Therefore, the print start location 112 is the starting boundary for printable area. The print start location 112 may also be referred to as a print boundary.

It should be noted that the printing device 102 may or may not start printing at the print start location 112. Rather, the print start location 112 is the place along the X-axis 120 where printing may begin. For example, if the printing device 102 is to print an image, in some cases, the image may start at the print start location 112. In these cases, the printing device 102 may begin printing at the print start location 112. In other cases, the image may begin after the print start location 112. In these cases, the printing device 102 may begin printing after the print start location 112. As used herein the term “starts printing” includes the printing device 102 beginning to apply a print substance to the print media or the printing device 102 entering a region in which printing could occur based on the content of the print job.

The distance traveled by the printing device 102 after sensing the print start marker 110 and before the printing device 102 starts printing is referred to as the print offset distance 116. The print offset distance 116 may be a configured distance traveled by the printing device 102. The print offset distance 116 may be a certain distance that the printing device 102 travels in the X-axis 120 before the printing device 102 starts printing. In some examples, the print offset distance 116 may be equal to zero. In other words, in this case, the printing device 102 may start printing immediately upon sensing the print start marker 110.

In some examples, the print offset distance 116 may be related to the position of the marker sensor 106 and a printhead 109 on the printing device 102. Therefore, the print offset distance 116 may be the distance that the printhead 109 moves after the marker sensor 106 senses the print start marker 110. For example, if the marker sensor 106 and the printhead 109 are located in different locations along the X-axis 120, then the print offset distance 116 may be different than a marker offset distance 115. As used herein, the distance between the print start marker 110 and the print start location 112 may be referred to as a marker offset distance 115. The marker offset distance 115 may have a configured relationship with the print offset distance 116. If the marker sensor 106 and the printhead 109 are co-located on the X-axis 120, then the print offset distance 116 may equal the marker offset distance 115.

In some examples, the print offset distance 116 and/or the print start location 112 may be configurable by a user. For instance, the print offset distance 116 and/or the print start location 112 may be configurable through a user interface. In some approaches, the user interface to configure the print offset distance 116 and/or the print start location 112 may be located on the printing device 102. In other approaches, the user interface to configure the print offset distance 116 and/or the print start location 112 may be implemented on a remote device (e.g., on an application of a remote computing device). Therefore, the print offset distance 116 and/or the print start location 112 may be adjustable (e.g., may be increased or decreased) by a user through the user interface.

In some examples, the marker sensor 106 may be an optical sensor to detect an optical pattern of the print start marker 110. In these examples, the print start marker 110 may be a visible object or feature on the print guide 104. For example, the print start marker 110 may be a dark bar, mirror, hole or other feature on the print guide 104 that is detectable by marker sensor 106.

In some examples, the optical marker sensor 106 may be implemented with a light-sensing component (e.g., photoresistor, photodiode, etc.). In some examples, the optical marker sensor 106 may also include a light-emitting component (e.g., light-emitting diode (LED)) to facilitate optical sensing of the print start marker 110. Other implementations of the optical marker sensor 106 may include an infrared sensor. In other implementations, the optical marker sensor 106 may be an optical through-beam. In yet other implementations, the optical marker sensor 106 may include a camera sensor to capture digital images.

The optical marker sensor 106 may detect the print start marker 110 based on changes in the optical signal measured by the marker sensor 106. For example, the marker sensor 106 may detect light regions of the print guide base 124 as not the print start marker 110. When the marker sensor 106 detects a dark region on the base 124, this may be interpreted by the printing device 102 as sensing the print start marker 110. Therefore, upon sensing a change in optical pattern (e.g., from light to dark or dark to light), the marker sensor 106 may trigger the detection of the print start marker 110.

In other examples, the marker sensor 106 may be a mechanical switch. In this implementation, the print start marker 110 may be a physical structure that actuates the mechanical switch. For example, the print start marker 110 may project from the print guide 104. As the printing device 102 moves over the print guide 104, the mechanical switch of the marker sensor 106 may contact the print start marker 110. This contact may be sensed by the marker sensor 106 to indicate a detection of the print start marker 110.

It should be noted that in the example illustrated in FIG. 1, the print start marker 110 is located on the base 124 of the print guide 104. In other examples, the print start marker 110 may be located on other regions of the print guide 104. For instance, the print start marker 110 may be located on side walls of the print guide 104. In this case, the marker sensor 106 may be located on a corresponding side of the printing device 102. For example, the marker sensor 106 may be located on a vertical side of the printing device 102 to detect a print start marker 110 positioned on the side of the print guide 104.

In some examples, the printing device 102 may include a distance measurement sensor 108 to measure distance traveled by the printing device 102. The distance measurement sensor 108 may measure the distance traveled by the printing device 102 upon detecting the print start marker 110. Once the marker sensor 106 senses the print start marker 110, the distance measurement sensor 108 may trigger a start of printing at the print start location 112. For example, the distance measurement sensor 108 may trigger a start of printing in response to determining that the printing device has traveled the configured print offset distance 116.

In an example, the printing device 102 may be placed on the print guide 104 such that the marker sensor 106 is positioned before the print start marker 110. In the example of FIG. 1, the printing device 102 may be placed on the left side of the print guide 104. As the printing device 102 is moved to the right, the marker sensor 106 may sense the print start marker 110. A signal may be communicated to the distance measurement sensor 108 to measure the distance moved by the printing device 102 when the marker sensor 106 detects the print start marker 110. When the distance measurement sensor 108 determines that the printing device 102 has moved the configured print offset distance 116, the distance measurement sensor 108 may trigger the printing device 102 to start printing.

In some examples, the distance measurement sensor 108 may be implemented as an encoder. For example, the encoder may be coupled to a wheel or axle of the printing device 102. In this implementation, the distance measurement sensor 108 may be coupled to a wheel that rotates as the printing device 102 moves. The distance measurement sensor 108 may be calibrated to determine distance based on the rotation of the wheel or axle of the wheel. In other examples, the distance measurement sensor 108 may measure distance using mechanisms other than an encoder. For instance, the distance measurement sensor 108 may be an optical distance measurement sensor that measures distance based on sensed optical signals. In some examples, the marker sensor 106 may also act as the distance measurement sensor 108. For instance, an optical marker sensor 106 may detect the print start marker 110 and may measure the distance moved by the printing device 102.

The print guide 104 may also include a reference marker 114. In some examples, the reference marker 114 may be located in relation to the print start location 112 to provide an accurate indication of the print start location 112 to a user. The reference marker 114 may be used to align the print guide 104 on the print media. For example, an edge or location (e.g., center) of the print media may be aligned with the reference marker 114.

In the example of FIG. 1, the reference marker 114 is located at the print start location 112. In other examples, the reference marker 114 may be offset from the print start location 112. For instance, the reference marker 114 may be offset from the print start location 112 to ensure an unprinted border on the print media. In another example, the reference marker 114 may be located in the center of the print media. In this example, the width of the print media may be used to determine the print start location 112 in relation to the print start marker 110. In other words, the print offset distance 116 may be configured based on the width of the print media.

The reference marker 114 may be painted, machined or formed on the print guide 104. For example, in one approach, the reference marker 114 may be painted on the print guide 104. In another approach, the reference marker 114 may be cut or etched into the print guide 104. In yet another approach, the reference marker 114 may be formed on the print guide 104 during fabrication of the print guide 104. In this approach, the reference marker 114 may be a recessed channel or raised projection.

In some examples, the reference marker 114 may be a line located on the print guide 104. In this approach, the reference marker 114 may be a line marked on the base 124 to align the print media with the print start location 112. In other examples, other shapes or patterns may be used for the reference marker 114.

In some examples, the print start marker 110 may be moveable to configure the print start location 112 in relation to the print start marker 110. For example, the print start marker 110 may be a moveable (e.g., slidable) structure that can be positioned in different locations on the print guide 104. In this approach, the print offset distance 116 may be reconfigured. In some implementations, the print start marker 110 may be a movable plastic flag that may slide to adjust the print start location 112.

In some examples, the reference marker 114 may be moveable on the print guide 104. In this approach, the reference marker 114 may be positioned based on print media size and/or print alignment (e.g., left, center, right, etc.).

The reference marker 114 may provide the user a very accurate representation of the start of the print. The use of the print start marker 110 in combination with the reference marker 114 improves image placement while using the print guide 104.

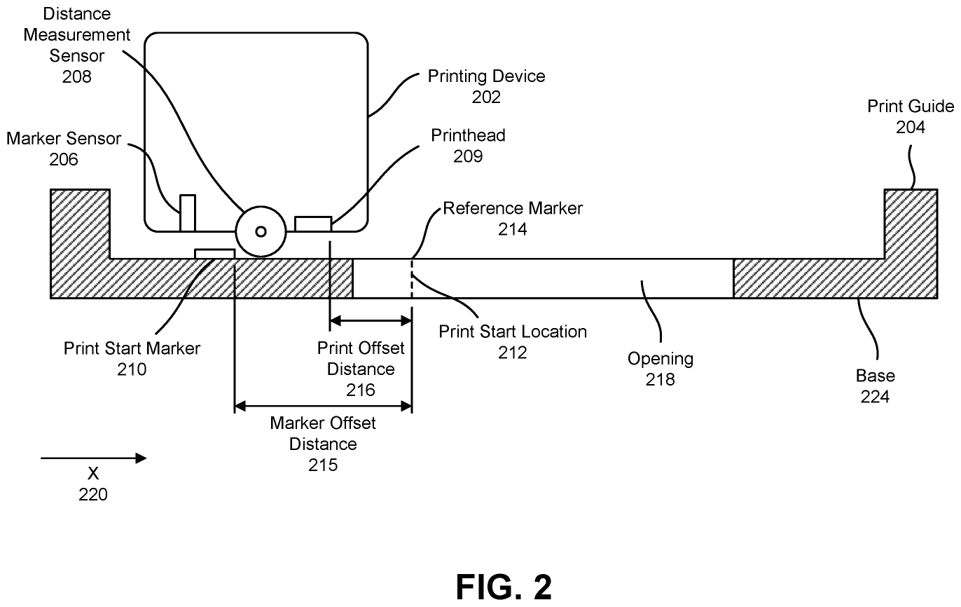

FIG. 2 is a cross section elevation view of an example of a printing device 202 and a print guide 204. The printing device 202 and print guide 204 may be implemented in accordance with the printing device 102 and the print guide 104 described in FIG. 1.

In this example, the printing device 202 has a maker sensor 206 to detect the print start marker 210 located on the base 224 of the print guide 204. The maker sensor 206 is oriented on the base of the printing device 202 to sense the print start marker 210. The print start marker 210 may be located on the print guide 204 at a marker offset distance 215 from the print start location 212.

The printing device 202 may print on the print media (not shown) positioned under the print guide 204. The printing device 202 may print through the opening 218 of the print guide 204.

In this example, the printing device 202 includes a distance measurement sensor 208 implemented as an encoder wheel. The distance measurement sensor 208 measures the distance traveled by the printing device 202 along the X-axis 220. Upon sensing the print start marker 210 by the maker sensor 206, the distance measurement sensor 208 may measure the distance moved by the printing device 202. The distance measurement sensor 208 may trigger the start of printing at the print start location 212 once the distance measurement sensor 208 determines that the printing device 202 has moved the print offset distance 216. In this example, the print offset distance 216 is configured as the distance between the printhead 209 and the print start location 212 when the marker sensor 206 detects the print start marker 210.

In some examples, the print guide 204 may also include a reference marker 214. In some examples, the reference marker 114 may be located in relation to the print start location 212 to provide an accurate indication of the print start location 212 to a user.

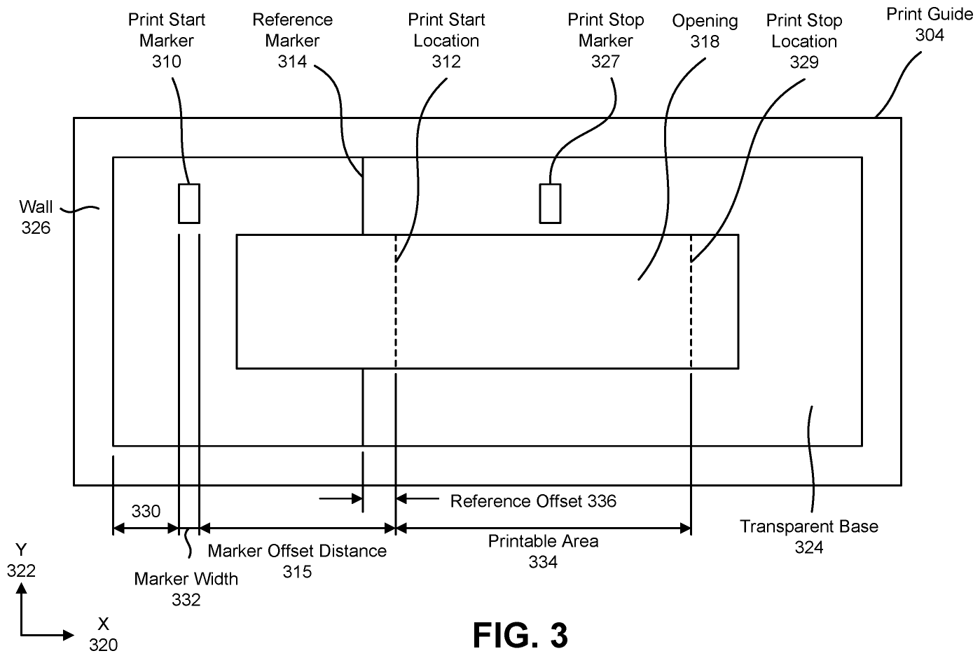

FIG. 3 is a plan view of an example of a print guide 304. The print guide 304 may be implemented in accordance with the print guide 104 described in FIG. 1.

In some examples, the print guide 304 may have a rectangular shape. For instance, the sides of the print guide 304 oriented along the X-axis 320 may be longer than the sides oriented along the Y-axis 322.

In some examples, the print guide 304 may also have a transparent base 324. For example, the base 324 of the print guide 304 may be fabricated from a transparent material (e.g., plastic, glass, etc.). The transparent base 324 may include an opening 318 to facilitate printing on a print media. The opening 318 may also be rectangular.

In some examples, the print guide 304 may have walls 326 surrounding the perimeter of the print guide 304. For example, the walls 326 may project up from the base 324 of the print guide 304. In some examples, the walls 326 may be sized and positioned to constrain movement of the printing device 102 in the Y-axis 322 while permitting movement of the printing device 102 in the X-axis 320.

A print start marker 310 may be located on the transparent base 324. The print start marker 310 may be detectable by a marker sensor 106 of the printing device 102 (not shown) as the printing device 102 moves on the print guide 304. The print start marker 310 may be used to trigger a start of printing by the printing device 102 at the print start location 312.

The print start marker 310 may be positioned a certain distance 330 from a side wall 326. For example, the distance 330 to the print start marker 310 may be sufficient to allow placement of a marker sensor 106 of the printing device 102 before the print start marker 310. In some examples, the print start marker 310 may have a configured marker width 332.

The marker offset distance 315 may be the distance from the print start marker 310 to the print start location 312. The marker offset distance 315 may be related to the print offset distance 116 used by the printing device 102 to trigger printing. The print start location 312 is the start of the printable area 334 where the printing device 102 may print on the print media.

In this example, the marker offset distance 315 starts at the end of the marker width 332. In other words, the printing device 102 may begin measuring the print offset distance 116 after sensing the end of the print start marker 310. In other examples, the print offset distance 116 may start at the beginning of the print start marker 310.

The print guide 304 may also include a reference marker 314. The reference marker 314 may be located in relation to the print start location 312 to provide an accurate indication of the print start location 312 to a user. In some examples, the reference marker 314 may be a line that spans the opening 318. The reference marker 314 may be used to align the print guide 304 on the print media. In some examples, the reference marker 314 may be offset from the print start location by a reference offset 336. The reference marker 314 may be oriented on either side of the print start location 312. For example, the reference marker 314 may be positioned on the print guide 304 based on the print alignment (e.g., left, center, right) of the print media.

In some examples, the print guide 304 may also include a print stop marker 327. The print stop marker 327 may be detectable by the printing device 102 to determine a print stop location 329. For example, the marker sensor 106 may detect the print stop marker 327. The print stop marker 327 may be used for an accurate detection of the print stop location 329. In some examples, the print stop location 329 may be a location where the printing device 102 stops printing. For example, upon detecting the print stop marker 327, the printing device 102 may continue to print for a certain distance before stopping printing at the print stop location 329. Therefore, in some examples, the print guide 304 may have two print markers. The print start marker 310 may be used to start the print and the print stop marker 327 may be used to stop the print.

Having an accurate print stop location 329 may be helpful for a repeating image with no set end position. For example, without a known print stop location 329, the user may have to stop the printing device 102 and lift it up. In this scenario, an inaccurate rainbow affect may occur at the end of the print due to the die spacing between cyan, yellow, and magenta. Using the print stop marker 327 to sense an accurate print stop location 329 will allow the printing device 102 to finish the print cleanly before the user lifts the printing device 102. This would also ensure that the printing device 102 stops printing and does not accidentally print onto the print guide 304.

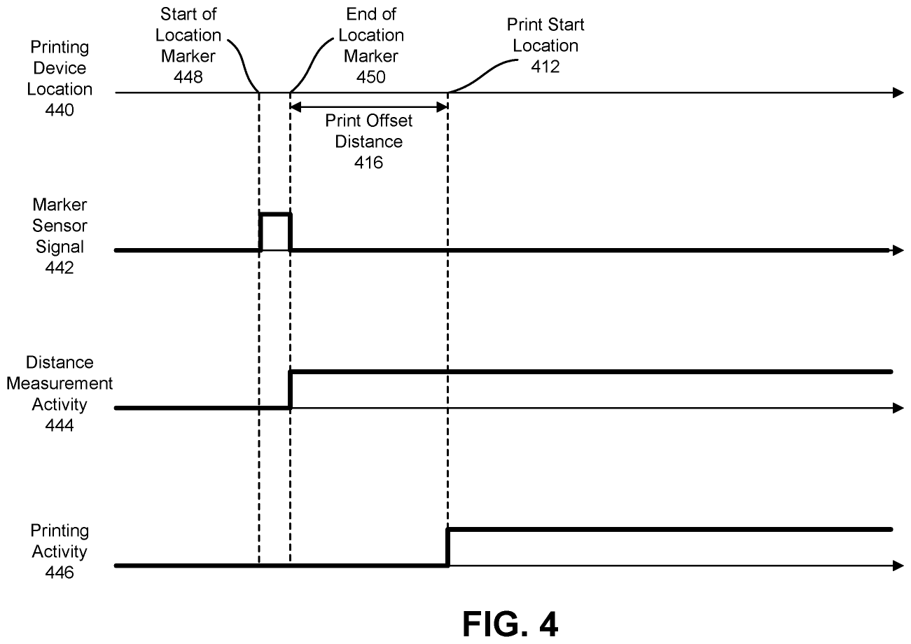

FIG. 4 illustrates examples of signals generated by the printing device 102. In this example, the signals are generated as the printing device 102 moves along the print guide 104. Therefore, the signals correspond to the printing device location 440 on the print guide 104.

When the printing device 102 begins moving, the marker sensor 106 of the printing device 102 does not detect the print start marker 110. Therefore, the marker sensor signal 442 may be low at the start of printing device movement. The low marker sensor signal 442 indicates that the marker sensor 106 does not detect the print start marker 110.

When the printing device 102 reaches the start 448 of the print start marker 110, the marker sensor signal 442 goes high. The marker sensor signal 442 may remain high until the end 450 of the print start marker 110.

When the marker sensor signal 442 transitions from high to low, this triggers the distance measurement sensor 108 to begin measuring the distance traveled by the printing device 102. Therefore, distance measurement activity 444 transitions from low (i.e., OFF) to high (i.e., ON) in response to the sensor signal transition. In this approach, the distance measurement sensor 108 is triggered on the high-to-low transition of the marker sensor signal 442. In other approaches, the distance measurement sensor 108 may be triggered on the low-to-high transition of the marker sensor signal 442.

When the distance measurement sensor 108 measures that the printing device 102 has moved the print offset distance 416, the distance measurement sensor 108 determines that the printing device 102 has reached the print start location 412. The distance measurement sensor 108 may then trigger the printing activity 446 to begin printing. In this example, a high signal for the printing activity 446 indicates that printing by the printing device 102 may occur.

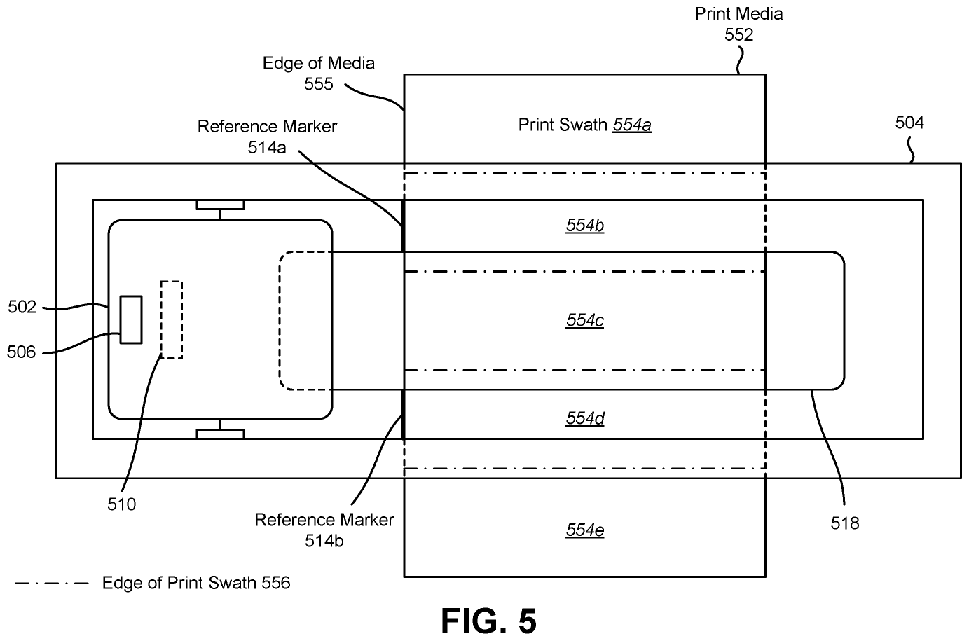

FIG. 5 is an example of multi-line sequence printing on a print media 552. A printing device 502 and print guide 504 may be implemented in accordance with the printing device 102 and print guide 104 described in FIG. 1. For example, the printing device 502 may include a marker sensor 506 to detect the print start marker 510 of the print guide 504.

In this example, the print guide 504 includes a first reference marker 514a and a second reference marker 514b located on both sides of an opening 518. The reference markers 514a-b are implemented as lines. An edge 555 of the print media 552 may be aligned with the reference markers 514a-b to achieve an accurate alignment of the start of printing.

In this example, multiple sequences of printing may be performed on the same print media 552 to create an image that is larger than a single pass of the printing device 502. This technique may be referred to as print swaths or stitching. A number of print swaths 554a-e may be printed on the print media 552 to create a single image.

In this example, the top of the print media 552 may be positioned under the print guide 504 to print the first print swath 554a. The print media 552 or the print guide 504 (or both) may then be moved to print the second print swath 554b. This process may be repeated until all of the print swaths 554a-e have been printed. The print media 552 may be aligned with the reference markers 514a-b for each print swath 554a. The edges 556 of the print swaths 554a-e are depicted as a dash-dot line in FIG. 5.

The addition of the accurate reference markers 514a-b indicating the start of print on the print guide 504 improves the ability of the user to align the edge 555 of the print media 552 while manually sequencing the print swaths 554a-e.

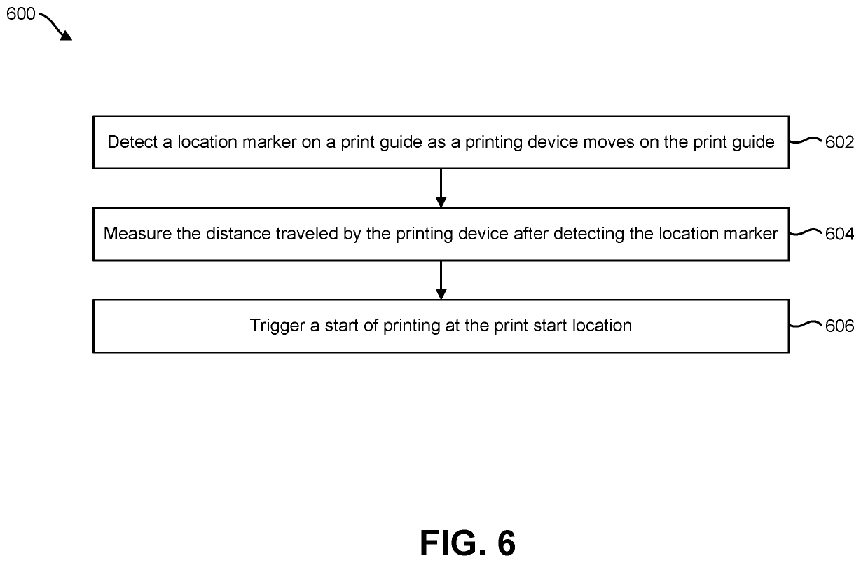

FIG. 6 is a flow diagram illustrating an example of a method 600 for accurate detection of a print start location. The method 600 may be implemented by a printing device 102. In some examples, the printing device 102 may be a handheld device. The printing device 102 may be positioned on a print guide 104. The print guide 104 may be physically separate from a print media.

The printing device 102 may detect 602 a print start marker 110 on a print guide 104 as the printing device 102 moves on the print guide 104. For example, the printing device 102 may include a marker sensor 106 to detect 602 the print start marker 110. The print start marker 110 may be located on the print guide 104 at a distance 116 before a print start location 112. The print guide 104 may have a reference marker 114 located in relation to the print start location 112 to provide an accurate indication of the print start location 112 to a user.

The printing device 102 may measure 604 distance traveled by the printing device 102 after detecting the print start marker 110. For example, the printing device 102 may include a distance measurement sensor 108 to measure how far the printing device 102 has moved in response to sensing the print start marker 110.

The printing device 102 may trigger 606 a start of printing at the print start location 112. For example, the printing device 102 may determine that the printing device 102 has travelled a configured print offset distance 116 from the print start marker 110. The start of printing may be triggered 606 in response to determining that the printing device 102 has travelled the configured print offset distance 116. In some examples, the print offset distance 116 that the printing device 102 travels after detecting the print start marker 110 and before the start of printing may be configured.

1. A printing device, comprising:
a marker sensor to detect a print start marker on a print guide as the printing device moves on the print guide, the print start marker being located on the print guide at a distance before a print start location, the print guide having a reference marker located in relation to the print start location to provide an accurate indication of the print start location to a user, the print guide being physically separate from a print media; and
a distance measurement sensor to measure distance traveled by the printing device after detecting the print start marker, the distance measurement sensor triggering a start of printing at the print start location.

2. The printing device of claim 1, wherein the marker sensor comprises an optical sensor to detect an optical pattern of the print start marker.

3. The printing device of claim 1, wherein the marker sensor comprises a mechanical switch.

4. The printing device of claim 3, wherein the print start marker comprises a physical structure that actuates the mechanical switch.

5. The printing device of claim 1, wherein the distance between the print start marker and the print start location comprises a configured marker offset distance.

6. The printing device of claim 1, wherein the distance measurement sensor measures the distance traveled by the printing device after detecting the print start marker and triggers the start of printing in response to determining that the printing device has traveled a configured print offset distance.

7. The printing device of claim 1, wherein the printing device is a handheld device.

8. A method, comprising:
detecting a print start marker on a print guide as a printing device moves on the print guide, the print start marker being located on the print guide at a distance before a print start location, the print guide having a reference marker located in relation to the print start location to provide an accurate indication of the print start location to a user, the print guide being physically separate from a print media;
measuring distance traveled by the printing device after detecting the print start marker; and
triggering a start of printing at the print start location.

9. The method of claim 8, further comprising:
determining that the printing device has travelled a configured print offset distance in response to detecting the print start marker; and
triggering the start of printing in response to determining that the printing device has travelled the configured print offset distance.

10. The method of claim 8, further comprising configuring a print offset distance that the printing device travels after detecting the print start marker and before the start of printing.

11. A print guide, comprising:
a print start marker located on the print guide at a distance before a print start location, the print start marker being detectable by a marker sensor of a printing device as the printing device moves on the print guide, the print start marker being used to trigger a start of printing by the printing device at the print start location; and
a reference marker located in relation to the print start location to provide an accurate indication of the print start location to a user, the print guide being physically separate from a print media.

12. The print guide of claim 11, further comprising a transparent base.

13. The print guide of claim 11, further comprising a print stop marker that is detectable by the marker sensor of the printing device to determine a print stop location.

14. The print guide of claim 11, further comprising an opening through which the printing device prints on the print media.

15. The print guide of claim 11, wherein the print start marker being movable to configure the print start location.
